(19) United States
(12) Patent Application Publication
(10) Pub. No.: US 2025/0309318 A1
(43) Pub. Date: Oct. 2, 2025

(54) BATTERY MANUFACTURING PROCESS TO REDUCE SWELLING

(71) Applicant: Lenovo (Singapore) Pte. Ltd., Singapore (SG)

(72) Inventors: Bouziane Yebka, Apex, NC (US); Jeremy Robert Carlson, Cary, NC (US); Philip J. Jakes, Durham, NC (US)

(21) Appl. No.: 18/622,464

(22) Filed: Mar. 29, 2024

(51) Int. Cl. H01M 10/04; H01M 10/44; H02J 7/00

(52) U.S. Cl. CPC H01M 10/04; H01M 10/443; H01M 10/446; H02J 7/0069; H02J 7/007182; H02J 7/007194

(57) ABSTRACT

A battery is charged and discharged during a battery manufacturing formation process according to a current and voltage profile. The duration of the charging at a high voltage level is maintained for an extended time period, thereby saturating a solid electrolyte interface (SEI) during the formation process and reducing a swelling of the battery.

### TECHNICAL FIELD

Embodiments described herein generally relate to preventing swelling in batteries, thereby enhancing longevity in the batteries, and in an embodiment, but not by way of limitation, preventing swelling in batteries by altering manufacturing parameters during the formation stage such as the duration of charging and discharging, the voltage range, temperature and cutoff voltage.

### BACKGROUND

The phenomenon of battery swelling is caused by various underlying issues, ranging from chemistry, misuse, or manufacturing flaws. Beyond the evident aesthetic concerns, including battery casings becoming visibly compromised, battery swelling can damage the battery system or pose potential harm.

### BRIEF DESCRIPTION OF THE DRAWINGS

In the drawings, which are not necessarily drawn to scale, like numerals may describe similar components in different views. Like numerals having different letter suffixes may represent different instances of similar components. Some embodiments are illustrated by way of example, and not limitation, in the figures of the accompanying drawings.

FIG. 1 is a diagram illustrating operations and features of a battery manufacturing process.

FIG. 2 is a diagram illustrating operations and features of a battery manufacturing process.

FIG. 2A illustrates parameters and cycle profiles of a battery manufacturing process.

FIG. 2B illustrates parameters and cycle profiles of a battery manufacturing process.

FIG. 3 is a diagram illustrating operations and features of a battery manufacturing process.

FIG. 3A illustrates parameters and cycle profiles of a battery manufacturing process.

FIG. 4 is a diagram illustrating operations and features of a battery manufacturing process.

FIG. 4A illustrates parameters and cycle profiles of a battery manufacturing process.

### DETAILED DESCRIPTION

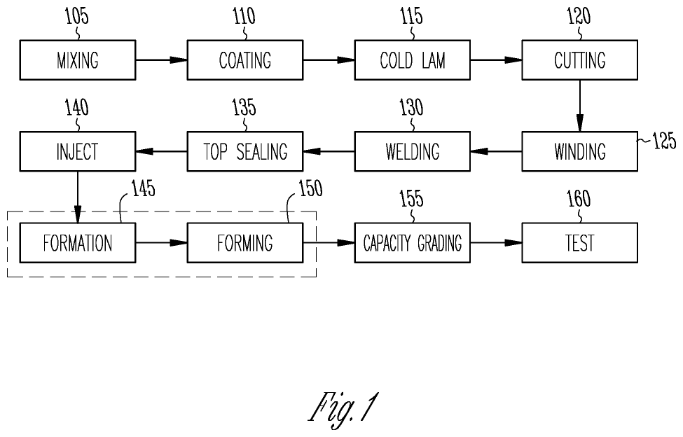

As indicated in FIG. 1, the battery manufacturing process consists of a plurality of steps, including mixing of the battery chemicals (105), coating a battery substrate with the chemicals (110), cold lamination of a separator onto an electrode (115), cutting the battery cells to size (120), winding the battery cells (125), welding the electrodes to the battery cells (130), top sealing of the battery casing (135), injection of additional chemicals and/or gases into the battery casing (140), formation (145) and forming (150) of battery tabs onto the battery cells, capacity grading of the battery (155) and testing (160) of the battery. The present disclosure focuses on the formation 145 and forming 150 operations.

As noted above, swelling in batteries can be a problem. In researching and studying this problem, the inventors of this disclosure have discovered that battery swelling accelerates during initial cycles and slows down over time. During the development of the embodiments disclosed herein, an examination of battery cells via a Scanning Electron Microscope (SEM) showed a minimum buildup on the electrode surface. Also, battery cell swelling follows a saturation process under extreme conditions (such as constant voltage). An SEM examination then shows excessive buildup on the electrode surface.

In an embodiment, the swelling can be saturated during the manufacturing process at the formation stage by extending the time at full charge and/or adjusting the charge rate based on the voltage range and/or a temperature variation based cutoff voltage. The formations stage refers to the battery cell's initial charging and discharging processes. The cells are then charged or discharged according to precisely defined current and voltage profiles. As an example, a first charging cycle can include a current of 0.1-0.5, with successive increases of the charge rate with each charging and charging cycle. The forming process can last up to fifteen hours. During formation, lithium ions are deposited in the graphite crystal structure on the anode side. This forms the Solid Electrolyte Interface (SEI), which is a boundary layer between the electrolyte and the electrode. The parameters during formation vary depending on the cell manufacturer and significantly impact the cell performance. The formation depends on the cell concept and the cell chemistry and represents the core knowledge of a cell manufacturer.

In this disclosure, three process alterations in the formation stage help prevent battery swelling. First, the charging of the battery during the formation process is extended. Second, the charge rate is adjusted based on the voltage range. Third, the temperature during charging is varied base on the cutoff voltage.

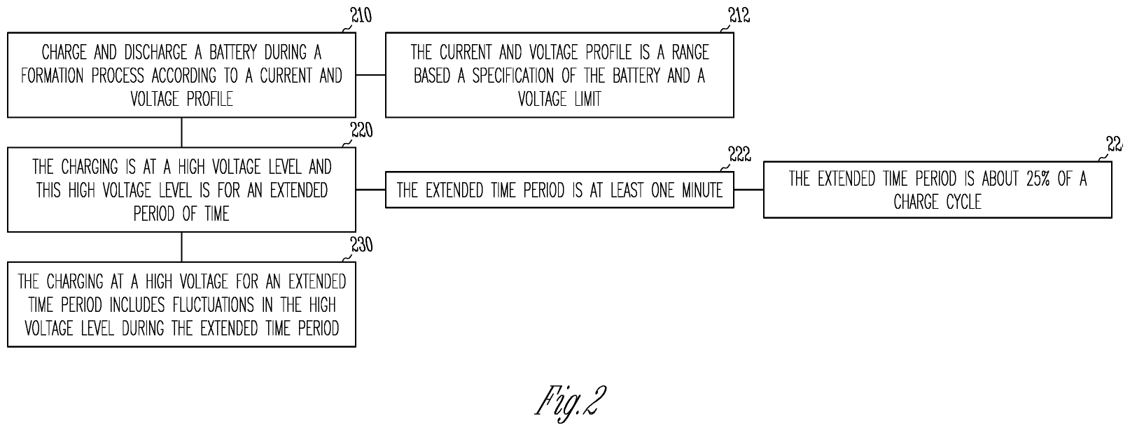

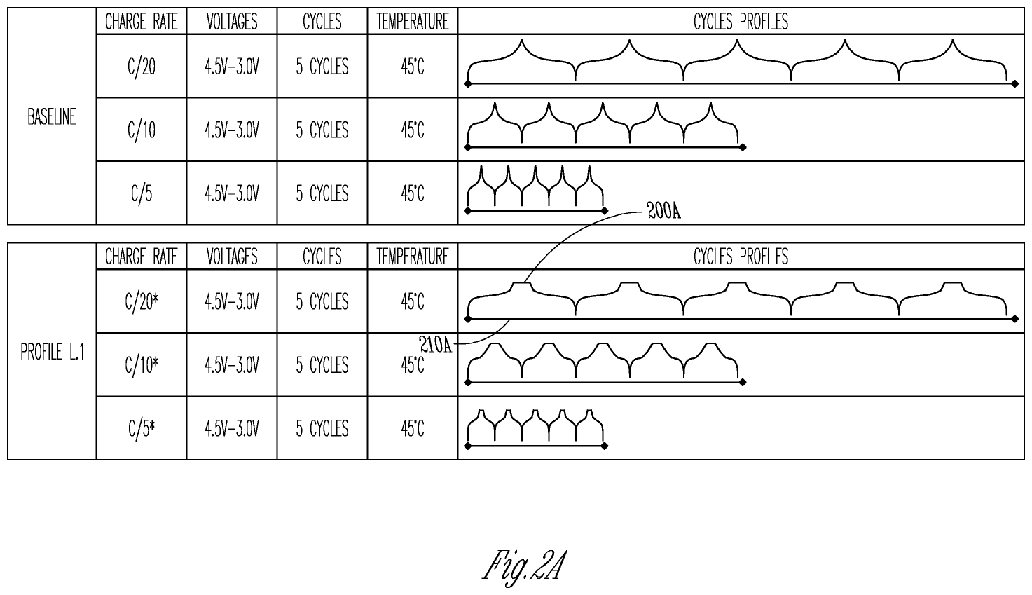

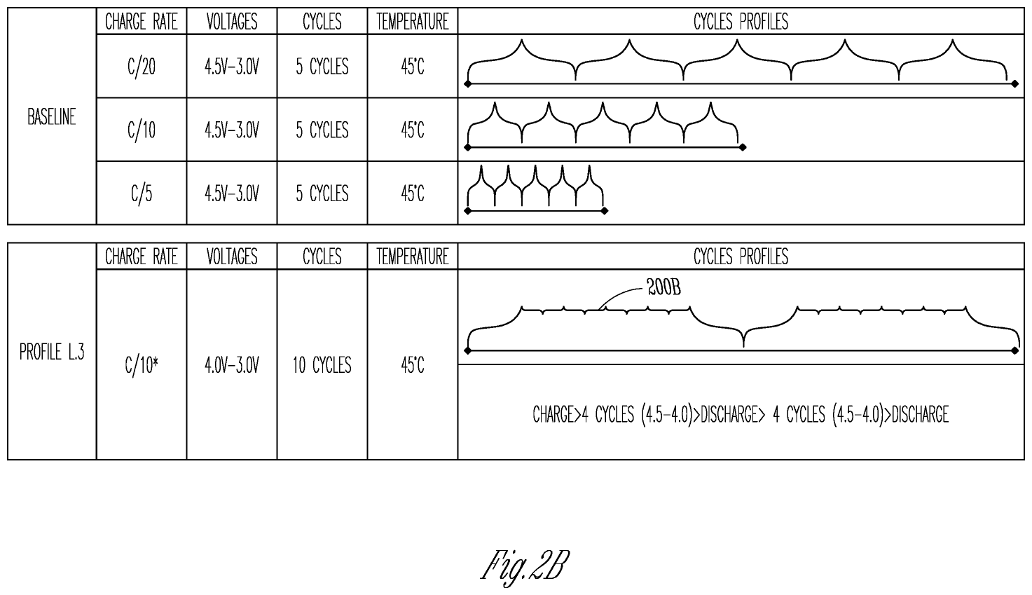

FIG. 2 is a diagram illustrating operations and features of a battery manufacturing process. FIG. 2A illustrates parameters and cycle profiles of a battery manufacturing process. FIG. 2B illustrates additional parameters and cycle profiles of a battery manufacturing process.

Referring now to FIGS. 2, 2A and 2B, in a formation process for manufacturing a battery, as indicated at 210, the battery is charged and discharged during a battery manufacturing formation process according to a current and voltage profile. In an embodiment, as indicated at 212, the current and voltage profile is a range based on a specification of the battery and a voltage limit. As is known to those of skill in the art, the voltage limits are set by the suppliers of the batteries based on the chemistry of the batteries.

As noted above in the discussion of FIG. 1, the formation process is one of a plurality of steps in the manufacture of a battery. The charging is at a high voltage level and this high voltage level is for an extended period of time (220). The high voltage level for an extended period of time saturates a solid electrolyte interface (SEI) of the battery and reduces the swelling of the battery. The extended time period is at least one minute (222), but it can be for several minutes in some examples. Put another way, the extended time period is about 25% of a charge cycle (224). This is illustrated in FIG. 2A, wherein the time period 200A is about 25% of the charge cycle 210A. As also illustrated in FIG. 2A, the high voltage can range from about 3.0 volts to 4.5 volts. In another embodiment, as indicated at 230, and as indicated in FIG. 2B at 200B, the charging at a high voltage for an extended time period includes fluctuations in the high voltage level during the extended time period.

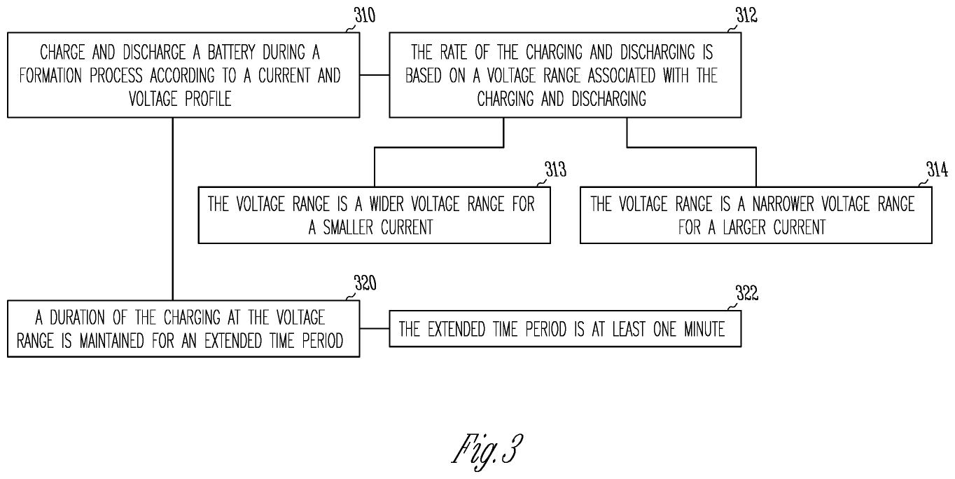

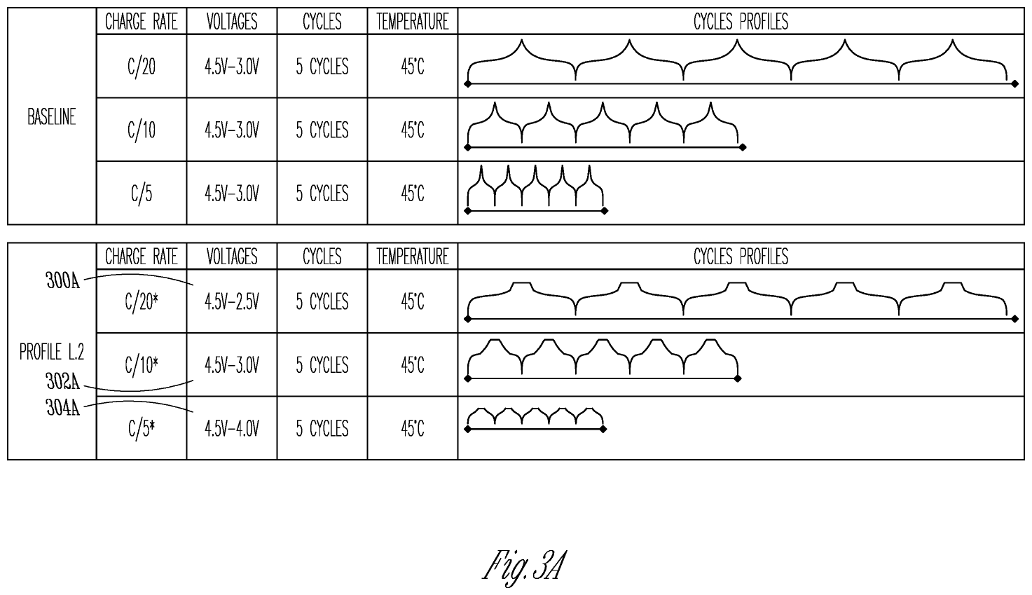

FIG. 3 is a diagram illustrating operations and features of a battery manufacturing process. FIG. 3A illustrates parameters and cycle profiles of a battery manufacturing process.

Referring now to FIGS. 3 and 3A, in a process for manufacturing a battery, as indicated at 310, a battery is charged and discharged during a battery manufacturing formation process according to a current and voltage profile. As indicated at 312, the rate of the charging and discharging is based on a voltage range associated with the charging and discharging. This charging rate based on the voltage range saturates a solid electrolyte interface (SEI) during the formation process and reducing a swelling of the battery.

Referring to FIG. 3A, three voltage ranges for different charge rates (i.e., current levels) are illustrated-a voltage range of 2.5-4.5 volts for a charge rate of C/20, a voltage range of 3.0-4.5 volts for a charge rate of c/10, and a voltage range of 4.0-4.5 volts for a charge rate of C/5. As indicated at 313, in an embodiment, the voltage range is a wider voltage range for a smaller current, and as indicated at 314 the voltage range is a narrower voltage range for a larger current. These different voltage ranges and levels are illustrated at 300A, 302A and 304A in FIG. 3A.

As indicated at 320, a duration of the charging at the voltage range is maintained for an extended time period, and as indicated at 322, the extended time period is at least one minute, but it can be for several minutes in some examples.

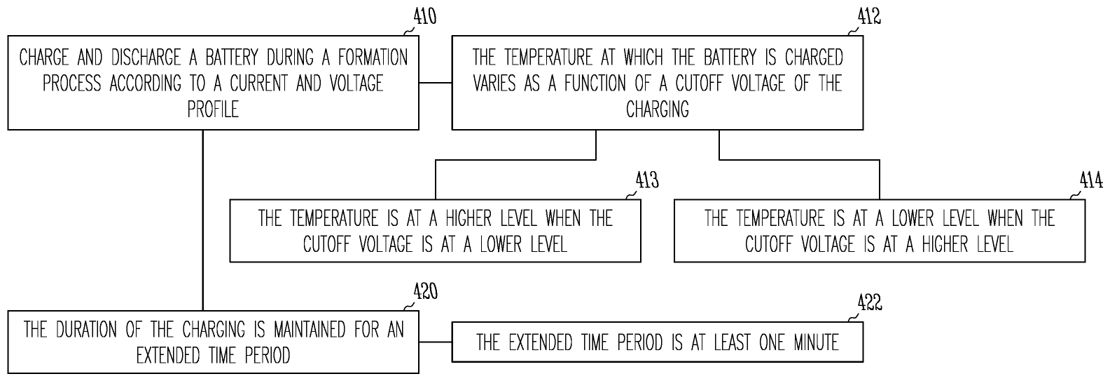

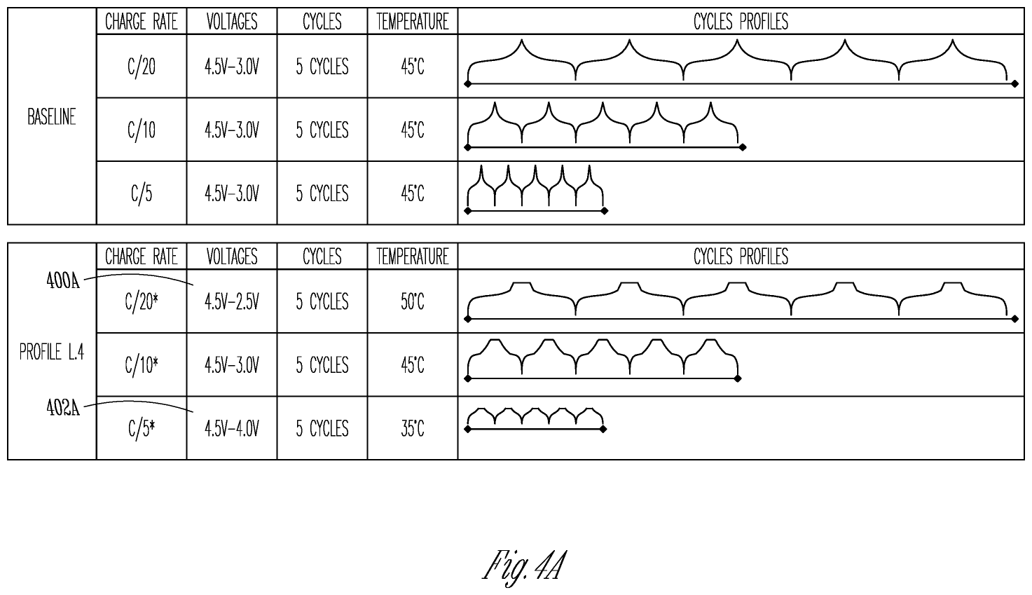

FIG. 4 is a diagram illustrating operations and features of a battery manufacturing process. FIG. 4A illustrates parameters and cycle profiles of a battery manufacturing process.

Referring now to FIGS. 4 and 4A, in a process for manufacturing a battery, at 410, a battery is charged and discharged during a battery manufacturing formation process according to a current and voltage profile. As indicated at 412, the temperature at which the battery is charged varies as a function of a cutoff voltage of the charging. This variation saturates a solid electrolyte interface (SEI) during the formation process and reduces swelling of the battery.

As indicated at 413 in FIG. 4 and at 400A in FIG. 4A, the temperature is at a higher level when the cutoff voltage is at a lower level. And as indicated at 414 in FIGS. 4 and 402A in FIG. 4A, the temperature is at a lower level when the cutoff voltage is at a higher level.

In an embodiment, the duration of the charging is maintained for an extended time period (420), and the extended time period is at least one minute (422), but it can be for several minutes in some examples.

The above detailed description includes references to the accompanying drawings, which form a part of the detailed description. The drawings show, by way of illustration, specific embodiments that may be practiced. These embodiments are also referred to herein as “examples.” Such examples may include elements in addition to those shown or described. However, also contemplated are examples that include the elements shown or described. Moreover, also contemplated are examples using any combination or permutation of those elements shown or described (or one or more aspects thereof), either with respect to a particular example (or one or more aspects thereof), or with respect to other examples (or one or more aspects thereof) shown or described herein.

Publications, patents, and patent documents referred to in this document are incorporated by reference herein in their entirety, as though individually incorporated by reference. In the event of inconsistent usages between this document and those documents so incorporated by reference, the usage in the incorporated reference(s) are supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to suggest a numerical order for their objects.

The above description is intended to be illustrative, and not restrictive. For example, the above-described examples (or one or more aspects thereof) may be used in combination with others. Other embodiments may be used, such as by one of ordinary skill in the art upon reviewing the above description. The Abstract is to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. However, the claims may not set forth every feature disclosed herein as embodiments may feature a subset of said features. Further, embodiments may include fewer features than those disclosed in a particular example. Thus, the following claims are hereby incorporated into the Detailed Description, with a claim standing on its own as a separate embodiment. The scope of the embodiments disclosed herein is to be determined with reference to the appended claims, along with the full scope of equivalents to which such claims are entitled.

### EXAMPLES

Example No. 1 is process for manufacturing a battery comprising charging and discharging the battery during a battery manufacturing formation process according to a current and voltage profile; wherein a duration of the charging at a high voltage level is maintained for an extended time period, thereby saturating a solid electrolyte interface (SEI) during the formation process and reducing a swelling of the battery.

Example No. 2 includes all the features of Example No. 1, and optionally includes a process wherein the extended time period comprises at least one minute.

Example No. 3 includes all the features of Example Nos. 1-2, and optionally includes a process wherein the extended time period comprises at least 25% of a charge cycle.

Example No. 4 includes all the features of Example Nos. 1-3, and optionally includes a process wherein the current and voltage profile comprises a range based a specification of the battery and a voltage limit.

Example No. 5 includes all the features of Example Nos. 1-4, and optionally includes a process wherein the charging at a high voltage for an extended time period comprises fluctuations in the high voltage level during the extended time period.

Example No. 6 is a process for manufacturing a battery comprising charging and discharging a battery during a battery manufacturing formation process according to a current and voltage profile; wherein a rate of the charging and discharging is based on a voltage range associated with the charging and discharging, thereby saturating a solid electrolyte interface (SEI) during the formation process and reducing a swelling of the battery.

Example No. 7 includes all the features of Example No. 6, and optionally includes a process wherein the voltage range comprises a wider voltage range for a smaller current.

Example No. 8 includes all the features of Example Nos. 6-7, and optionally includes a process wherein the voltage range comprises a narrower voltage range for a larger current.

Example No. 9 includes all the features of Example Nos. 6-8, and optionally includes a process wherein a duration of the charging at the voltage range is maintained for an extended time period.

Example No. 10 includes all the features of Example Nos. 6-9, and optionally includes a process wherein the extended time period comprises at least one minute.

Example No. 11 is a process for manufacturing a battery comprising charging and discharging a battery during a battery manufacturing formation process according to a current and voltage profile; wherein a temperature at which the battery is charged varies as a function of a cutoff voltage of the charging, thereby saturating a solid electrolyte interface (SEI) during the formation process and reducing a swelling of the battery.

Example No. 12 includes all the features of Example No. 11, and optionally includes a process wherein the temperature is at a higher level when the cutoff voltage is at a lower level.

Example No. 13 includes all the features of Example Nos. 11-12, and optionally includes a process wherein the temperature is at a lower level when the cutoff voltage is at a higher level.

Example No. 14 includes all the features of Example Nos. 11-13, and optionally includes a process wherein a duration of the charging is maintained for an extended time period.

Example No. 15 includes all the features of Example Nos. 11-14, and optionally includes a process wherein the extended time period comprises at least one minute.

1. A process for manufacturing a battery comprising:
charging and discharging the battery during a battery manufacturing formation process according to a current and voltage profile;
wherein a duration of the charging at a high voltage level is maintained for an extended time period, thereby saturating a solid electrolyte interface (SEI) during the formation process and reducing a swelling of the battery.

2. The process for manufacturing a battery of claim 1, wherein the extended time period comprises at least one minute.

3. The process for manufacturing a battery of claim 1, wherein the extended time period comprises at least 25% of a charge cycle.

4. The process for manufacturing a battery of claim 1, wherein the current and voltage profile comprises a range based a specification of the battery and a voltage limit.

5. The process for manufacturing a battery of claim 1, wherein the charging at a high voltage for an extended time period comprises fluctuations in the high voltage level during the extended time period.

6. A process for manufacturing a battery comprising:
charging and discharging a battery during a battery manufacturing formation process according to a current and voltage profile;
wherein a rate of the charging and discharging is based on a voltage range associated with the charging and discharging, thereby saturating a solid electrolyte interface (SEI) during the formation process and reducing a swelling of the battery.

7. The process for manufacturing a battery of claim 6, wherein the voltage range comprises a wider voltage range for a smaller current.

8. The process for manufacturing a battery of claim 6, wherein the voltage range comprises a narrower voltage range for a larger current.

9. The process for manufacturing a battery of claim 6, wherein a duration of the charging at the voltage range is maintained for an extended time period.

10. The process for manufacturing a battery of claim 9, wherein the extended time period comprises at least one minute.

11. A process for manufacturing a battery comprising:
charging and discharging a battery during a battery manufacturing formation process according to a current and voltage profile;
wherein a temperature at which the battery is charged varies as a function of a cutoff voltage of the charging, thereby saturating a solid electrolyte interface (SEI) during the formation process and reducing a swelling of the battery.

12. The process for manufacturing a battery of claim 11, wherein the temperature is at a higher level when the cutoff voltage is at a lower level.

13. The process for manufacturing a battery of claim 11, wherein the temperature is at a lower level when the cutoff voltage is at a higher level.

14. The process for manufacturing a battery of claim 11, wherein a duration of the charging is maintained for an extended time period.

15. The process for manufacturing a battery of claim 14, wherein the extended time period comprises at least one minute.
